(19) United States
(12) Patent Application Publication
(10) Pub. No.: US 2007/0233937 A1
(43) Pub. Date: Oct. 4, 2007

(54) Reliability of write operations to a non-volatile memory

(76) Inventors: Richard L. Coulson, Portland, OR (US); Gianpaolo Spadini, Campbell, CA (US); Neal R. Mielke, Lost Altos Hills, CA (US)

Correspondence Address: TROP PRUNER & HU, PC, 1616 S. VOSS ROAD, SUITE 750, HOUSTON, TX, 77057-2631, US

(21) Appl. No.: 11/396,262

(22) Filed: Mar. 31, 2006

(51) Int. Cl. G06F 12/00

(52) U.S. Cl. 711/103

(57) ABSTRACT

In one embodiment, the present invention includes a method for writing data into both a volatile portion and an erase block of a non-volatile portion of a storage device, and maintaining the data in the volatile portion until the data is successfully written to the erase block. In this way, enhanced data reliability is provided. Other embodiments are described and claimed.

### BACKGROUND

Today's computer systems provide for ever-increasing amounts of processing capabilities. Combined with these capabilities is a greater need for storage capacity. In addition to raw capacity, data must be efficiently retrieved in order to avoid slowing down the process of useful work in a processor of a system. Accordingly, various memory technologies have been proposed for use in a system to improve data capacity and also to accommodate greater bandwidth of data retrieval. Memory technologies including memories such as non-volatile memories such as semiconductor memories, polymer ferroelectric memories (PFEMs), magnetic memories, ovonics-based memories and other such memories have been developed or proposed for use in computer systems.

Certain of these memory technologies such as semiconductor memories including flash-based technologies may be arranged in a block-oriented manner. That is, a memory may be formed of a number of blocks. In certain memory technologies, before being able to write data to a block, the block must first be placed into a known state, i.e., an erased state. Accordingly, such technologies include blocks in the form of so-called erase blocks. One such memory technology is a NAND-based flash technology. While such memories are suitable for high speed write and read operations, errors can occur during these read and write operations, as well as during an erase operation to ready a block for writing. Such failures can lead to a loss of data. Given the high reliability requirements of systems, particularly enterprise-based systems, such errors are to be avoided if at all possible to provide a product that can meet stringent data stability requirements of various systems.

### BRIEF DESCRIPTION OF THE DRAWINGS

FIG. 1 is a flow diagram of a method in accordance with one embodiment of the present invention.

FIG. 2 is a flow diagram of a more detailed method in accordance with an embodiment of the present invention.

FIG. 3 is a block diagram of a storage device in accordance with one embodiment of the present invention.

FIG. 4 is a block diagram of a computer system in which embodiments of the invention may be used.

### DETAILED DESCRIPTION

In various embodiments, techniques may be used to ensure accuracy of data being written to a memory device, particularly such a device arranged in a block-oriented manner. That is, various techniques may be used to store data being written to the memory in a buffered location and maintain that data in the buffered location until it is confirmed that all data written to a given block of the memory has been successfully written. By maintaining incoming data to the memory in a buffered location, data recovery measures can be performed if a write or other operation to a block of the memory fails. Such recovery techniques may be implemented whether a single page of the block suffers an error, or an error to a page causes an entire block to be compromised.

As will be described further below, particular embodiments may be implemented in a NAND-based non-volatile memory technology, although the scope of the present invention is not limited in this regard. Such NAND-based memory devices may be used as storage products for various system types. For example, in some embodiments a solid state disk may be formed using the NAND-based memory technology. In other embodiments, a disk cache or other cache memory may be implemented using the NAND-based memory technology.

While variations are possible, embodiments of the present invention may be implemented in a storage device that includes a non-volatile memory array and a volatile array. The non-volatile memory array may include a number of segments arranged as blocks. These blocks are referred to herein as erase blocks, since in a NAND-based technology before data can be written the block must be first erased (i.e., cells of the block are set to a logic zero level). These blocks each may be formed of a plurality of pages. In some embodiments, the volatile memory buffer associated with the non-volatile storage device may be the same or substantially the same size as a single erase block of the storage device. In this way, incoming data may be buffered in the volatile memory buffer and maintained until an entire erase block is successfully written. Embodiments may include further control logic, such as a controller or driver to enable read, write and other control operations to be performed on the storage device. Such a controller or driver may be implemented as hardware, firmware, software or combinations thereof, in various embodiments.

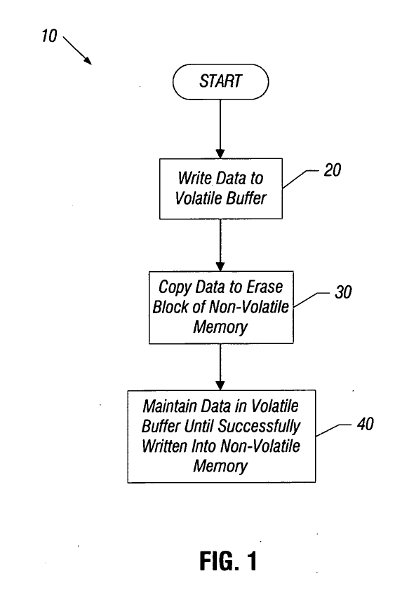

Referring now to FIG. 1, shown is a flow diagram of a method in accordance with one embodiment of the present invention. Method 10 may be used to obtain and store data into a non-volatile storage device, such as a solid state disk or cache (e.g., a disk cache) coupled between a disk drive and a processor. In some implementations, method 10 may be performed by a controller or driver associated with the storage device, although the scope of the present invention is not so limited.

Referring still to FIG. 1, data may first be written to a volatile buffer (block 20). For example, incoming data corresponding to write requests from an operating system (OS) (e.g., from an OS driver) may be written to a dynamic random access memory (DRAM) buffer, although other variations such as a static random access memory (SRAM) are possible. This buffer may be sized substantially the same as an erase block of the non-volatile memory array of the memory device, in some implementations. Note that while the volatile buffer may be part of the memory device in many embodiments, in other implementations the volatile buffer may be located elsewhere in a system. Furthermore, it is noted that this erase block-sized volatile buffer is in addition to a page-sized volatile buffer that interfaces to the non-volatile memory array.

In turn, the data may be copied from the buffer to a selected erase block of the non-volatile memory (block 30). Each erase block may include a plurality of individual pages, each of which may be written to individually. The copying of data from the buffer to the erase block may be performed sequentially as data is received by the buffer, or in some embodiments multiple writes may be written into the buffer and then at a later time the buffer contents may be copied to the erase block. Note that in other embodiments, blocks 20 and 30 may be performed in parallel and the data may be written both to the buffer and the erase block simultaneously or substantially simultaneously. Note that the copying over to the erase block typically may be performed on a page by page basis as write commands are received. However, erase block-sized transfers may occur for long data transfers, i.e., transfers larger than an erase block.

As described above, because errors can occur in writing to an erase block, protections may be taken to ensure that data is not corrupted or lost. More particularly, one possible failure mechanism is that a write to a single page of an erase block can cause a failure to not only that page, but to the entire erase block.

Accordingly, to protect data in such an event, method 10 may maintain data in the volatile buffer until all data is successfully written into the non-volatile memory array (block 40). That is, the buffer may maintain the data that is stored therein until an entire erase block is successfully written (i.e., filled). Note that if the erase block is not completely filled, the volatile buffer will lose its contents on powering off of the system. Then on a next power up, data may be written to the same erase block or a new erase block, depending on a given implementation. While described with this particular high-level methodology with regard to FIG. 1, it is to be understood that the scope of the present invention is not so limited and various manners of protecting data until an erase block is successfully written can be realized.

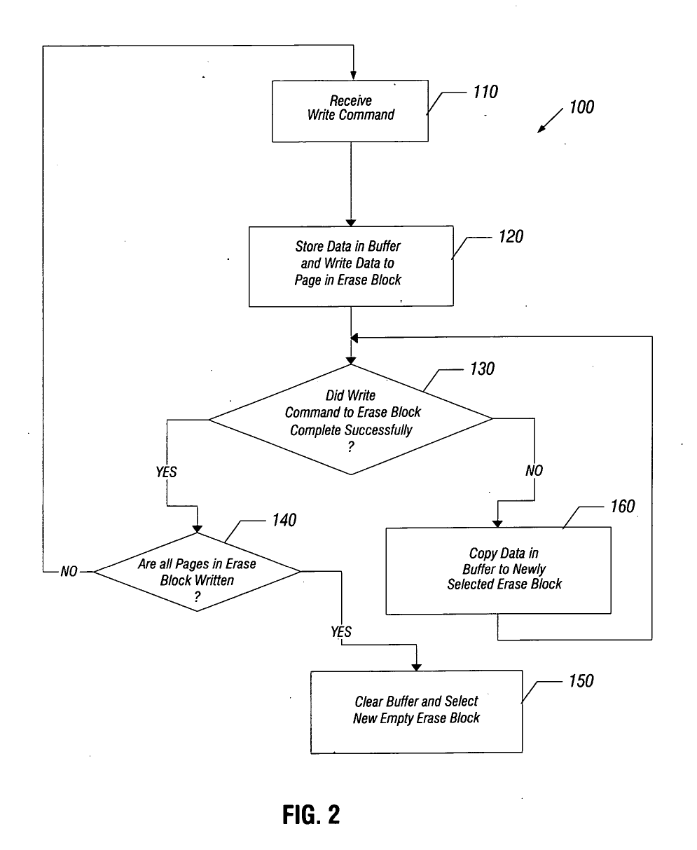

Referring now to FIG. 2, shown is a flow diagram of a more detailed method in accordance with one embodiment of the present invention. As shown in FIG. 2, method 100, which may also be performed by a controller or driver of the non-volatile memory device, may begin by receiving a write command (block 110). The write command may be received from an OS, e.g., a driver of the OS that handles writing of data to mass storage. When the command is received, the data may be stored in a buffer and written to a page of an erase block (block 120). While in many implementations, the data may be written to the volatile buffer and the erase block in that order, the scope of the present invention is not limited in this regard. In some implementations, e.g., where the data to be written to the erase block is already present in another storage of the system, e.g., a cache memory or a disk drive, the data may be written to the erase block and then to the volatile buffer. As described above, this buffer may be sized to be substantially the same size as an erase block.

Still referring to FIG. 2, next it may be determined whether the write command to the erase block successfully completed (diamond 130). If so, control passes to diamond 140. There it may be determined whether all pages of the erase block have been written (diamond 140). That is, it may be determined whether the erase block is full. If not, control passes back to block 110, discussed above, where method 100 may wait for receipt of a next write command.

If instead at diamond 140 it is determined that the erase block is complete (i.e., is full), control passes to block 150. There, the buffer may be cleared and a new empty erase block may be selected (block 150). Thus because the previous erase block was successfully filled, the copy of the data in the buffer may be cleared. The clearing may take various forms. In one embodiment, all data in the buffer may be invalidated so that it may be overwritten. In another embodiment, the data may be erased. By selection of a new empty erase block, additional incoming data may be stored thereto. Thus while not shown for ease of illustration, method 100 may continue by returning from block 150 to block 110 for receipt of a next write command.

Still referring to FIG. 2, if instead at diamond 130 it is determined that the write to a page of the erase block did not complete successfully, control passes to block 160. There, the data in the buffer may be copied to a newly selected erase block (block 160). That is, to prevent corruption of data in the first erase block having at least one page that did not write correctly, the entire contents of the buffer may be copied to a new erase block. Furthermore, to prevent future errors, the original erase block that had an error may be marked as a bad block so that it is not selected for future writes. From block 160, control passes back to diamond 130, discussed above. While described with this particular implementation in the embodiment of FIG. 2, the scope of the present invention is not so limited.

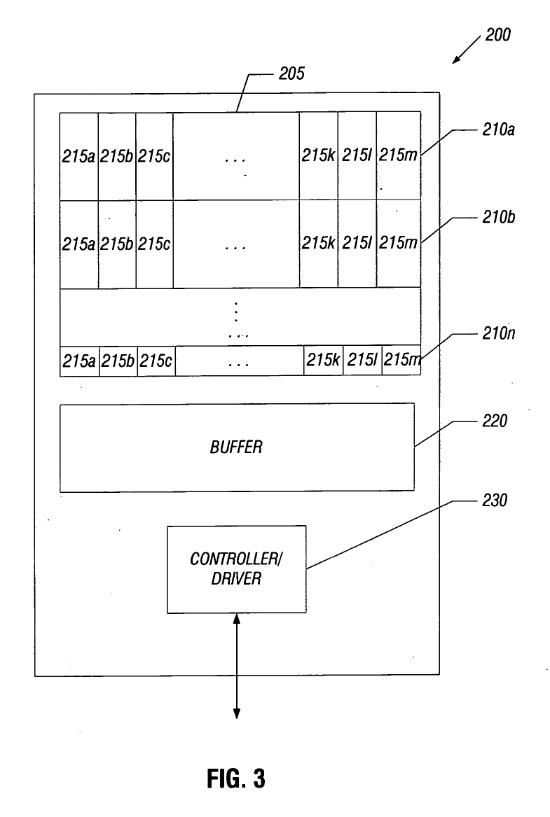

Referring now to FIG. 3, shown is a block diagram of a storage device in accordance with one embodiment of the present invention. As shown in FIG. 3, storage device 200 may be a mass storage device or other storage for use in a system. As shown in FIG. 3, storage device 200 may include a non-volatile memory array 205 formed of a plurality of individual erase blocks 210a-210n (generically, erase block 210). Each erase block 210 may be formed of a plurality of individual pages 215a-215m (generically, page 215), with each group of pages forming one erase block 210. Also included in memory device 200 may be a page-sized volatile buffer that interfaces to non-volatile memory array 205 (not shown in FIG. 3 for ease of illustration). While the scope of the present invention is not limited in this regard, each erase block 210 may be formed of 64 pages. While the form of non-volatile memory array 205 may vary, in some embodiments, a NAND-based technology may be used.

To prevent a failure in a single page 215 from corrupting an entire erase block 210, a volatile buffer 220, which may be a dynamic random access memory (DRAM) in some embodiments, may be present. Buffer 220 may be sized substantially the same as a given erase block 210. Accordingly, incoming data when being written to storage device 200 may be written into buffer 220 for buffering until an entire erase block 210 to which the incoming data is routed is successfully filled. Note that while buffer 220 is shown as part of memory device 200 in the embodiment of FIG. 3, the scope of the present invention is not limited in this regard. In other implementations, buffer 220 may be located apart from memory device 200.

Writing and control of buffer 220 and non-volatile memory array 205 may be under control of a controller and/or driver 230 (hereafter controller 230). In some embodiments, a driver may be present, while in other embodiments, a controller formed of control logic may be used to implement read and write operations within storage device 200. It is to be understood that controller 230 may be implemented using hardware, software, or firmware, or combinations thereof.

In operation, incoming data, e.g., provided via a driver associated with an OS may be provided to controller 230. Controller 230 may then provide the data to buffer 220. In some implementations, the data may be provided both to buffer 220 and a given erase block 210 directly from controller 230, e.g., simultaneously. If the data is only provided to buffer 220, an independent operation to copy the data from buffer 220 to a given erase block 210 may further be implemented by controller 230. Note that in some embodiments, additional structures may be present in storage device 200, such as address or hash tables such as a logical to physical address table, for example. While described with this particular implementation in the embodiment of FIG. 3, it is to be understood that the scope of the present invention is not limited in this regard.

In some implementations, incoming data may be striped across multiple non-volatile memory arrays. For example, with reference still to FIG. 3, in some implementations a storage device may include multiple non-volatile memory arrays. Such multiple arrays may be used for data striping. Alternately or in combination, data may be mirrored to multiple drives to ensure data redundancy. In such embodiments, a volatile buffer may be sized to be substantially the same size as the number of different memory arrays multiplied by the size of given erase block. Alternately, multiple buffers each associated with a given non-volatile memory array may be used.

Still further, in some embodiments a non-volatile memory array may have multiple channels that operate independently. Because each channel is writing to a single erase block at a given time, a volatile buffer may be associated with each such channel. Note that in all these implementations, multiple buffers need not be present. Instead, a single volatile memory device (e.g., a DRAM) can have different regions dedicated to each such buffer.

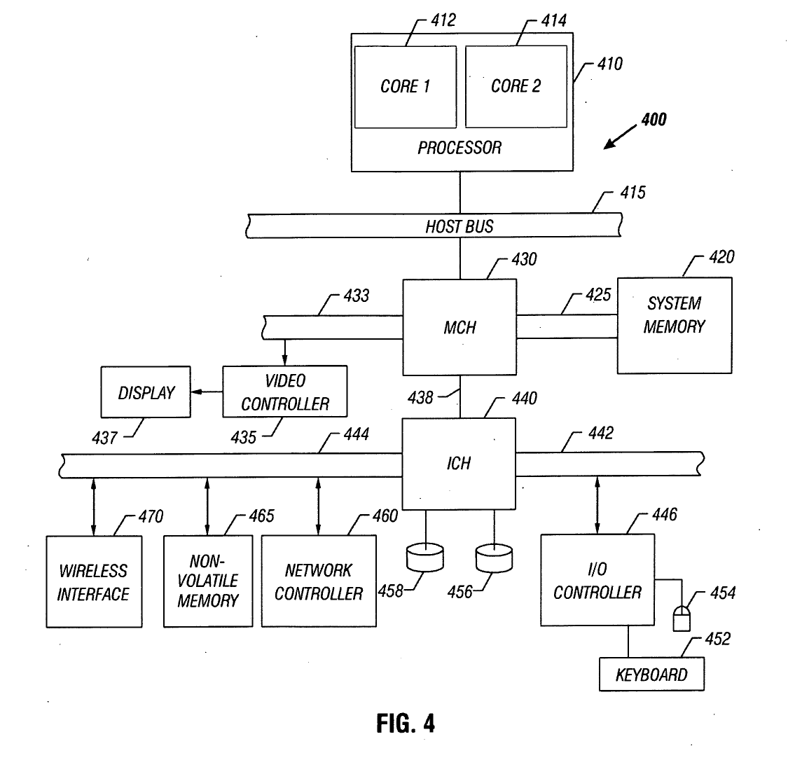

Using embodiments of the present invention, a non-volatile memory device may thus meet an unrecoverable error specification in that errors occurring during write operations that impact either a single page or an entire erase block can be recovered. Embodiments of the present invention may be implemented in many different system types. FIG. 4 is a block diagram of a computer system 400 in which embodiments of the invention may be used. As used herein, the term “computer system” may refer to any type of processor-based system, such as a notebook computer, a server computer, a laptop computer, a desktop computer or the like. In one embodiment, computer system 400 includes a processor 410, which may be a multicore processor including a first core 412 and a second core 414. Processor 410 may be coupled over a host bus 415 to a memory controller hub (MCH) 430 in one embodiment, which may be coupled to a system memory 420 (e.g., a DRAM) via a memory bus 425. MCH 430 may also be coupled over a bus 433 to a video controller 435, which may be coupled to a display 437.

MCH 430 may also be coupled (e.g., via a hub link 438) to an input/output (I/O) controller hub (ICH) 440 that is coupled to a first bus 442 and a second bus 444. First bus 442 may be coupled to an I/O controller 446 that controls access to one or more I/O devices. As shown in FIG. 4, these devices may include in one embodiment input devices, such as a keyboard 452 and a mouse 454. ICH 440 may also be coupled to, for example, multiple hard disk drives 456 and 458, as shown in FIG. 4. Such drives may be two drives of a redundant array of individual disks (RAID) subsystem, for example. It is to be understood that other storage media and components may also be included in the system. Further, instead of drives 456 and 458, one or more solid state disks in accordance with an embodiment of the present invention may be present. Second bus 444 may also be coupled to various components including, for example, a network controller 460 that is coupled to a network port (not shown). As further shown in FIG. 4, a wireless interface 470 may be coupled to second bus 444. Wireless interface 470 may include an antenna, such as a dipole antenna and may be adapted to communicate wirelessly between system 400 and a remote device via a desired wireless protocol.

As further shown, a non-volatile memory 465, which may be a non-volatile memory in accordance with an embodiment of the present invention, may further be coupled to second bus 444. In such embodiments, non-volatile memory 465 may act as a disk cache between disk drives 456 and 458 and processor 410. In other embodiments, instead of a disk cache, non-volatile memory 465 may take the place of disk drives 456 and 458. In this way, a solid state disk may be provided that can be used to maintain data with mechanisms to ensure compliance with an unrecoverable error specification. Note that in some embodiments, a solid state disk in accordance with an embodiment of the present invention may be coupled to system 400 via a Serial-Advanced Technology Attachment (S-ATA) protocol in accordance with the Serial ATA 1.0a Specification (published Feb. 4, 2003) or a so-called Fibre Channel protocol. Of course, such a device can be coupled to system 400 according to other protocols in other embodiments.

Embodiments may be implemented in code and may be stored on a machine-accessible medium such as a storage medium having stored thereon instructions which can be used to program a system to perform the instructions. The storage medium may include, but is not limited to, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
writing data into a volatile storage and an erase block of a non-volatile portion of a storage device; and
maintaining the data in the volatile storage until all portions of the erase block are successfully written.

2. The method of claim 1, further comprising writing the data from the volatile storage to a second erase block of the non-volatile portion if a write to at least a portion of the erase block fails.

3. The method of claim 1, further comprising receiving the data from a driver and storing the data in the volatile storage prior to writing the data to the erase block.

4. The method of claim 1, wherein a size of the volatile storage is substantially equal to a size of the erase block.

5. The method of claim 1, further comprising invalidating the data in the volatile storage if the erase block is successfully filled.

6. The method of claim 5, further comprising:
writing new data to the volatile storage after the invalidating the data; and
writing the new data from the volatile storage to a different erase block of the non-volatile portion.

7. An article comprising a machine-accessible medium including instructions that when executed cause a system to:
sequentially store data in a buffer and write the data in a respective page of an erase block of a non-volatile memory for each of multiple write operations; and
maintain the data in the buffer until the erase block is successfully completed.

8. The article of claim 7, further comprising instructions that when executed cause the system to determine if an error occurs in the sequential writes and, if so, sequentially write the data to a different erase block.

9. The article of claim 8, further comprising instructions that when executed cause the system to sequentially write the data to the different erase block from the buffer.

10. The article of claim 7, further comprising instructions that when executed cause the system to mark the erase block as a bad block if an error occurs during the sequential writes.

11. The article of claim 7, further comprising instructions that when executed cause the system to reclaim the buffer when all portions of the erase block are successfully written.

12. An apparatus comprising:
a volatile memory buffer to store incoming data;
a non-volatile memory array coupled to the volatile memory buffer, the non-volatile memory array including a plurality of erase blocks; and
a controller to maintain the incoming data in the volatile memory buffer at least until an erase block of the non-volatile memory array is successfully filled with the incoming data, the incoming data of multiple write operations.

13. The apparatus of claim 12, wherein the controller is to cause the incoming data in the volatile memory buffer to be copied to a different erase block if a failure occurs during a write to a portion of the erase block.

14. The apparatus of claim 12, wherein the apparatus comprises a mass storage device.

15. The apparatus of claim 14, wherein the non-volatile memory array comprises a NAND-based memory.

16. The apparatus of claim 12, wherein the volatile memory buffer is substantially the same size as an erase block of the non-volatile memory array.

17. The apparatus of claim 12, wherein the controller is to select a different erase block for writing after the erase block is successfully filled.

18. The apparatus of claim 12, further comprising a plurality of volatile memory buffers to store incoming data, each of the plurality of volatile memory buffers substantially the same size as an erase block of the non-volatile memory array.

19. The apparatus of claim 18, wherein the controller is to cause incoming data of a first channel to be stored in a first one of the plurality of volatile memory buffers and to cause incoming data of a second channel to be stored in a second one of the plurality of volatile memory buffers.

20. The apparatus of claim 18, wherein the controller is to cause simultaneous writing of a first and second erase block of the non-volatile memory array with the incoming data from first and second ones of the plurality of volatile memory buffers, respectively.

21. A system comprising:
a processor to execute instructions of an operating system (OS);
a non-volatile storage coupled to the processor, the non-volatile storage including at least one non-volatile memory array and at least one volatile buffer, wherein the at least one volatile buffer is to store data of incoming write requests issued by the OS until an erase block of the non-volatile memory array has been successfully filled; and
a dynamic random access memory (DRAM) coupled to the processor.

22. The system of claim 21, wherein the non-volatile storage comprises a solid state disk.

23. The system of claim 22, wherein the at least one non-volatile memory array comprises a NAND array.

24. The system of claim 21, wherein the non-volatile storage comprises a first and second non-volatile memory array and the at least one volatile buffer comprises an internal DRAM of the non-volatile storage.

25. The system of claim 24, wherein the internal DRAM includes a first buffer to store data for the first non-volatile memory array and a second buffer to store data for the second non-volatile memory array.

26. The system of claim 21, wherein the at least one non-volatile memory array comprises a single array having a plurality of channels, wherein the at least one volatile buffer comprises a plurality of buffers each corresponding to one of the plurality of channels.
